(19) United States
(12) Patent Application Publication
(10) Pub. No.: US 2012/0146297 A1
(43) Pub. Date: Jun. 14, 2012

(54) TEXTILE MATERIAL IMPREGNATED WITH WATER BASE SOLUTION

(76) Inventor: Juan Antonio MAYER GOYENECHEA CABALLERO, Zinacantepec (MX)

(21) Appl. No.: 13/313,770

(22) Filed: Dec. 7, 2011

Related U.S. Application Data
(60) Provisional application No. 61/420,873, filed on Dec. 8, 2010.

(51) Int. Cl. F16J 15/10; C09D 7/12; B29C 43/24; C09D 109/08; B32B 5/02; B32B 17/02

(52) U.S. Cl. 277/650; 442/59; 442/180; 264/175; 524/446

(57) ABSTRACT

The present invention refers to a textile formed by fiberglass impregnated with a water base elastomeric mixture, to substitute the aromatic base solvent elastomeric mixture and other types (acetates, ketones, alcohols, aliphatics, gas solvents, chlorates, glycoethers and mixtures such as Thinner Standard) used in the entire world and by doing so, offer a non-contaminating product to both the environment as well as to humans, given that it can cause brain, movement, cognitive, and learning problems through the inhalation of the solvent in the environment as it acts as a VOC contaminant given the high carbon content and the evaporation at room temperature which the solvent exhibits.

### CROSS-REFERENCE TO RELATED APPLICATION

This application claims the benefit of provisional application Ser. No. 61/420,873 filed on Dec. 8, 2010.

### FIELD OF INVENTION

The present invention refers to the creation of a textile material, for example rubberized fiber glass textile, which is used to create among others, joints and insulating seals intended for high temperature, in ovens, autoclaves, dryers etc., where the joints are used for unions, flushed flanges, boiler turtles, joints with hand entrance and male entrance, insulation in tubing, tanks, pressure recipients, deposits, autoclaves, mixers or equipment subjected to high temperatures, as well as high pressures, insulating or sealing against vapor, gas, oils and any other type of fluids. Specifically, the present invention refers to a textile material impregnated with a water base solution.

### BACKGROUND

Previous art generally makes known fiber glass products impregnated with a mixture of different types of rubbers, which are usually diluted in a solvent base, generally aromatic solvents, within which toluene and xylene are highlighted (aromatic solvent types), white colored, where the aromatic solvents used in previous art are dangerous to those in direct contact with the solvent at the time of applying the refinish, since the high volatility of these solvents makes their vapor easily penetrable through the respiratory airways and quickly reaching the circulatory system of the person in contact. The solubles are additionally, generally lipo-soluble, which allows them to easily cross the blood brain barrier and reach the central nervous system.

Once inhaled, the vapors emitted by these types of substances, are quickly absorbed through the lungs and later reach the brain. Part of the effects is due to the reduction in the amount of oxygen which enters the organism during its aspiration. The inhalation of solvents causes the general organic functions such as respiration and heart rhythm to become depressed or slow down. Repeated use of deep inhalations can cause a type of “overdose” resulting in disorientation, loss of control and unconsciousness. After the inhalation and in the hours that follow, dizziness and drowsiness can occur, in addition to headaches and inability to concentrate.

Prolonged contact with the solvents (for example 5 or more years) can result in great damage to brain function, particularly affecting control of movement and the cognitive and learning abilities.

In similar manner, the solvents can act as volatile organic compounds (VOC), harmful to the environment since they are organic chemical compounds which mainly affect the air. VOCs include gasoline, industrial compounds such as benzene, and solvents such as toluene, xylene and percloethylene (the most used solvent for dry cleaning). All organic compounds contain carbon and constitute the basic component of living matter and all derivatives of the same. Many of the organic components we use are not found in nature, but rather, are obtained synthetically. The volatile chemical compounds easily emit vapors. The emanation of vapors from liquid compounds is quickly produced at room temperature. The VOCs emanate from the combustion of gasoline, wood, carbon and natural gas, and from solvents, paints, colas and other products commonly used in homes or in industry. The emanations of vehicles also constitute an important source of VOCs. Many volatile organic compounds are dangerous contaminants to the airways. For example, benzene has carcinogenic effects.

### BRIEF DESCRIPTION OF THE INVENTION

The present invention provides fiber glass impregnated for joints and insulating seals, where the solvent base is eliminated, such as the aromatics, ketones, alcohols, aliphatics, gas solvents, chlorates, glycoethers and mixtures (Thinner Standard) for the impregnation. Specifically, the present invention employs, in order to impregnate the fiber glass; a water base solution and as a benefit has managed to diversify the gamut of colors on the textile including for example a light blue by means of the addition of pantones. In the same manner, other colors can be opted for by following established standards by the applicant, standards established by the consumer, or pre-established norms, without devaluing the product's operational conditions. Additionally, the present invention improved the performance of the fiber glass impregnation, due to having attained a longer lasting adhesiveness to the textile.

Thus, the present invention refers to a textile material which is impregnated with an elastomeric mixture which does not contain an aromatic solvent or any other type. The preferred textile is a fiber glass cloth.

The fiber glass textile is a fibrous material obtained upon making the molten glass flow through a piece with very fine holes, such as a spinneret, and upon solidifying it has sufficient flexibility to be used as a fiber. Within its main properties, fiber glass has good thermal insulation, inert to acids and capable of withstanding high temperatures. The dry material resists temperatures of up to about 450° C., while the impregnated one resists temperatures up to 300° C. with a 20 bar work pressure.

On the joints of the present invention, the use of fiber glass is preferred, especially in light of the high temperature systems, such as boilers, tanks and tubing, among others. Even though this textile can be used in dry or impregnated form, the impregnated textile is preferred whose impregnation be with an elastomeric mixture with which fiber detachment can be eliminated, and thus adequately use the fiber in joints and rationalize the use of raw material. The body of the joints is made by doubling and adhering strips of the impregnated cloth, recovered or treated, in such a way that there is an adequate coupling on the contact surface, at the joint or flange and properly accomplishes the necessary seal.

Another function of the impregnation is to provide a fluid seal such as can be vapor, oils, gas, etc. granting a seal-ability which allows these equipments to safely operate within the norms of emissions towards the atmosphere. That is, the basic function of the impregnated textile is that it be insulating, avoiding the flow of temperature through the textile, sealing fluids, whether liquid or gas, as well as vapors, oils, solvents etc. with a determined pressure and temperature.

This substantial improvement in the mixture for the impregnation is what makes the product of the present application be different than the rest of the available products in the market to date, as well as the pigmentation of said mixture which is selected under exclusive design.

Thus, one of the objectives of the present invention, is to provide a textile impregnated with an elastomeric mixture which does not contain aromatic or similar solvents, such as for example ketones, alcohols, aliphatics, gas solvents, chlorates, glycoethers and mixtures such as Thinner Standard, and which do not present risks to both the environment as well as to persons in direct contact with the material. An objective correlated to the previous is to attain an ecological product, free of aromatic or other type of solvents as well as substances dangerous to health and consequently, to eliminate dangerous by-products.

Another objective of the present invention is to provide an identification system of the textile by means of the pigmentation of the material in different colors for easier and more efficient manipulation, both at the intake, as well as at the disposal of the material, in the equipment where the product shall be used, the simplest identification of the product, having the ability to be both at storage as well as in the work zone of the product, or in equipment with a defined use. A co-related objective of the present invention is to achieve a product with defined color to identify the pieces in the market.

It is yet another objective of the present invention to achieve a cost effective product competitively priced to compete with solvent base materials.

Yet another objective of the present invention is to provide a material resistant to temperature and pressure for joints and seals, which can displace hazardous materials in the joints and seals, such as are asbestos or materials impregnated with solvents which are used in the market, providing the operators both durability and safety.

It is yet another objective of the present invention to provide a joint or seal impregnated with the water base solvent of the present invention. Furthermore, another correlated objective with the previous one is to provide a fiberglass joint or seal impregnated with the water base solvent of the present invention.

Another objective of the present is a material capable of withstanding work conditions of up to 300° C. with a 20 bar pressure.

To comply with the objectives, the applicant has developed an adequate product, in such a way that each product complies with one specific requirement, and each product has a type of production, a type of construction (mixture used in textile impregnation), which influences both the structure of the product, as well as the type of material combination.

### BRIEF DESCRIPTION OF THE FIGURES

FIG. 1 represents a seal or joint EV 180 style: fiberglass cloth impregnated with water base elastomeric mixture in white color.

FIG. 2 represents a seal or joint EV 180 B1 style: fiberglass cloth impregnated with water base elastomeric mixture in light blue color.

### BRIEF DESCRIPTION OF THE INVENTION

According to the present invention, the applicant has developed a water base impregnation system for textiles, eliminating risk situations both for the environment, the factory workers and no less importantly, for the end user of the impregnated textile, especially for textile fibers, such as can be fiberglass.

Collateral to the base mixture, the ability to identify a new product with a special distinctive color for application to boilers was developed, for example a light blue, or even available in any other color by means of the addition of pantones, according to the required need.

Additionally, the product's end user can operate in high safety without requiring additional protection, repairing or providing maintenance to these equipments, it is possible to safely react to determine the type of residue to which the product to be replaced will convert into.

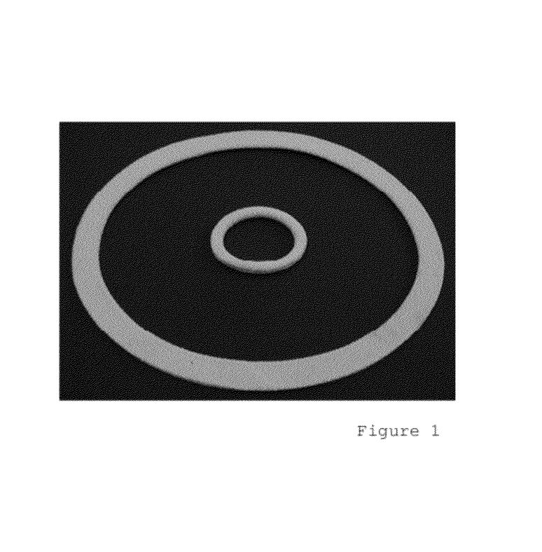

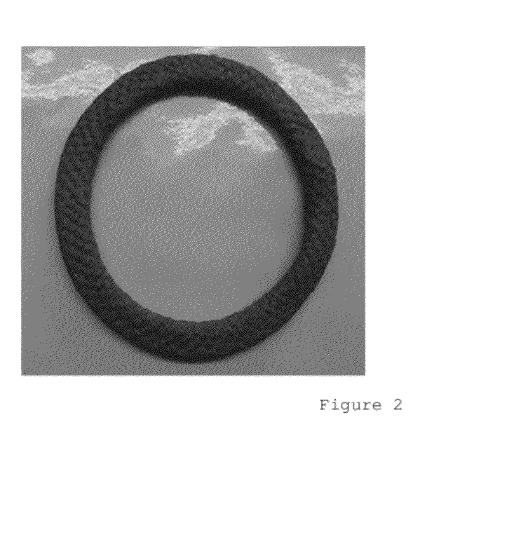

To better understand the fiberglass cloth impregnated with the water base elastomeric mixture, FIGS. 1 and 2 are presented.

The following tables relate the preferred water base components to be able to undergo the impregnation in cloths, especially the fiberglass cloths. The given ranges in the tables are “approximate” and in weight percent. The approximate term allows a variation ranging between 0 to 10% of the lower range and of the upper range. As an example, the term from 5 to 7 minutes can mean from 5 to 7 minutes, as well as 4:30 to 7 minutes, 5 to 6:18 minutes, 4:30 to 6:18 minutes, 5:50 to 7:42 minutes, 4:30 to 7:42 minutes etc.

Composition 1

| COMPONENT | % |
|---|---|
| STYRENE BUTADIENE LATEX | 30-90 |
| NATURAL LATEX | 10-40 |
| KAOLIN | 10-40 |
| TITANIUM DIOXIDE | 10-35 |
| ANTIOXIDANT | 10-35 |
| FUNGICIDE | 10-35 |
| WATER | 10-35 |
| ACCELERANT | 0-10 |

Composition 2

| COMPONENT | % |
|---|---|
| NATURAL LATEX | 30-90 |
| KAOLIN | 10-35 |
| TITANIUM DIOXIDE | 10-40 |
| ANTIOXIDANT | 10-35 |
| FUNGICIDE | 10-35 |
| WATER | 10-35 |
| ACCELERANT | 0-10 |

Composition 3

| COMPONENTE | % |
|---|---|
| STYRENE BUTADIENE LATEX | 30-90 |
| NATURAL LATEX | 10-40 |
| KAOLIN | 10-35 |
| TITANIUM DIOXIDE | 10-35 |
| ANTIOXIDANT | 10-35 |
| FUNGICIDE | 10-35 |
| WATER | 10-35 |
| BLUE PHTHALOCYANINE | 10-35 |
| ACCELERANT | 0-10 |

Composition 4

| COMPONENT | % |
|---|---|
| NATURAL LATEX | 30-90 |
| KAOLIN | 10-40 |
| TITANIUM DIOXIDE | 10-40 |
| ANTIOXIDANT | 10-35 |
| FUNGICIDE | 10-35 |
| WATER | 10-35 |
| BLUE PHTHALOCYANINE | 10-35 |
| ACCELERANT | 0-10 |

Other types of latex can be used as a substitute to the styrene butadiene latex, such as nitrile butadiene. The nitrile butadiene latex can be used to complement the compositions. Any suitable conventional accelerant or accelerator may be used. The amount of accelerant is less than 10 wt %, and may be in the range of 0.1 to 10 wt %.

The materials mentioned grant special properties within the mixture. For example, the latex provides the refinish over the textile, thus encapsulating the textile's fiber, specially the fiberglass, thus granting in equal form the adhesive property to the textile. The titanium dioxide whitens the mixture. The antioxidant avoids oxidation of the latex. The fungicide protects the fiber of the textile from fungi formed by moisture. The water creates a homogenous dilution. The kaolin acts as a thickener to the mixture. The alternative materials provide color, such as is the case with the blue phthalocyanine and the pantones. The vulcanizing agent provides a faster drying of the impregnation.

The mixture of the compositions takes place in a mixture system by means of propellers within a special agitator. All the components are mixed for a period varying about between 5 and 15 minutes to be followed by the textile impregnation.

The textile impregnation takes place by means of a calendaring process, where the textile is impregnated with the support of rollers through which the amount of the mixture over the fiberglass can be controlled. After the impregnation, the textile is cured in a drying oven at a temperature varying between about 70 and 90° C., this grants the fiberglass the rubbery property, with which it is encapsulated to make it more manageable without the need of using skin protection, granting in even form the gluing system for the formation of joints which shall be used in equipment such as boilers, ovens, among others.

The impregnation of mixture of the water base composition in its different pigmentations was tested at the applicant's installations by means of a temperature resistance test with water vapor to force the maximum operational conditions of the textile to be felt, which can be reached in any field, in this way covering the possible “curing-vulcanizing” ranges, the summarized description of the test is the following:

| Time | Temperature |
|---|---|
| 1 Hour | 50° C. |
| 4 Hours | 75° C. |
| 4 Hours | 150° C. |
| 4 Hours | 300° C. |

So that the textile be approved, it must resist the temperature and the vapor, presenting a certain flexibility, since should the piece appear rigid and not be able to resist said conditions, it will cause breakage to the textile. In the same manner, it must leave the least possible marks within the test device, since that is indicative of minimum elastomeric detachment during the test.

### EXAMPLES OF USE

The following examples are illustrative in character and should in no way be interpreted as limitative.

### Example 1

### Fiberglass Cloth Impregnated with Elastomeric Mixture Water Base and White and Blue Colors

CONSTRUCTION: Woven cloth packaging based on textured fiberglass filaments, impregnated with a water base elastomeric mixture and with a color according to the requested style, thickeners of 0.8, 1, up to 3 mm, and widths varying from 1 to 1.80 meters and lengths of 50 meters.
APPLICATIONS: The packaging can be used in vapor, solvents, oils, organic chemicals, except for acids with a pH of 4 or lower and highly concentrated alkalis, as insulation in general, to manufacture joints for boilers, packaging for autoclaves, oven doors, etc.

### Conditions of Service:

Temperature: Maximum white and blue color: 300° C. (572° F.)
Pressure: Maximum white and blue color: 20 bar (290 psi)

### Approximate Kilograms Per Linear Meter:

| 1/16″ | ⅛″ | ¼″ | ⅜″ | ½″ | ¾″ | 1″ |
|---|---|---|---|---|---|---|
| 1.736 | 3.500 | 7.000 | N/A | N/A | N/A | N/A |

Alterations to the disclosed structure in the present specification, may be predicted by those skilled in the art. However, it should be understood that the present specification is related with the preferred embodiments of the invention, which is for illustrative purposes only, and should not be construed as a limitation of the invention. All the amendments that do not depart from the spirit of the invention shall be included within the scope of the attached claims.

What is claimed is:

1. A textile material for joints and insulating seals, wherein the textile material is impregnated with a water base elastomeric mixture.

2. The textile material according to claim 1, wherein said textile material is fiberglass cloth.

3. The textile material according to claim 1, wherein the water base elastomeric mixture comprises:
about 30-90% of styrene-butadiene latex;
about 10-40% of kaolin;
about 10-35% of titanium dioxide;
about 10-35% of antioxidant;
about 10-35% of fungicide; and
about 10-35% of water.

4. The material according to claim 3, wherein the mixture additionally comprises:
about 0.1-10% of the accelerant;
about 10-40% of natural latex; and
about 10-40% of blue phthalocyanine.

5. The textile material according to claim 4 wherein the mixture comprises:
about 10-35% of natural latex.

6. The textile material according to claim 1, wherein the textile resists temperatures up to 300° C. and pressures up to 20 bar.

7. A process to manufacture an impregnated fiber glass used to create insulting joints and seals which comprises:
a) preparing a water base elastomeric mixture;
b) impregnating a fiber glass with a water-base elastomeric mixture by means of a calendaring process, where the fiber glass is impregnated with the support of rollers; and
c) curing the impregnated fiber glass in a drying oven.

8. The procedure according to claim 7, wherein the curing temperature varies about between 70° C. and 90° C.

9. The procedure according to claim 7, wherein the water base elastomeric mixture comprises:
about 30-90% of styrene-butadiene latex;
about 10-40% of kaolin;
about 10-35% of titanium dioxide;
about 10-35% of antioxidant;
about 10-35% of fungicide; and
about 10-35% of water.

10. The procedure according to claim 9, wherein the mixture additionally comprises:
about 0.1-10% of the accelerant;
about 10-40% of natural latex; and
about 10-35% of blue phthalocyanine.

11. The procedure according to claim 10, wherein the mixture additionally comprises:
about 10-35% of natural latex.

12. An insulating fiber glass joint or fiber glass seal for equipment which works in wide range of temperature and pressure conditions, the insulating joint or seal is impregnated with a water base elastomeric mixture which comprises:
about 30-90% of styrene-butadiene latex;
about 10-40% of kaolin;
about 10-35% of titanium dioxide;
about 10-35% of antioxidant;
about 10-35% of fungicide; and
about 10-35% of water.

13. The insulating joint or seal according to claim 12, wherein the mixture additionally comprises:
about 0.1-10% of the accelerant;
about 10-40% of natural latex; and
about 10-35% of blue phthalocyanine.

14. The insulating joint or seal according to claim 13, wherein the mixture additionally comprises
about 10-35% of natural latex.

15. A water base elastomeric mixture to be used in the manufacture of insulating joints and seals for equipment used in a wide range of temperature and pressure conditions, where said mixture comprises:
about 30-90% of styrene-butadiene latex;
about 10-40% of kaolin;
about 10-35% of titanium dioxide;
about 10-35% of antioxidant;
about 10-35% of fungicide; and
about 10-35% of water.
